(19) United States
(12) Patent Application Publication
(10) Pub. No.: US 2011/0013053 A1
(43) Pub. Date: Jan. 20, 2011

(54) DEFECTIVE PIXEL DETECTION AND CORRECTION

(76) Inventors: Rui CHEN, Sichuan (CN); Mark WONG, Union City, CA (US)

Correspondence Address: O2MICRO INC;C/O MURABITO, HAO & BARNES LLP, TWO NORTH MARKET STREET, THIRD FLOOR, SAN JOSE, CA, 95113, US

(21) Appl. No.: 12/568,954

(22) Filed: Sep. 29, 2009

Related U.S. Application Data
(60) Provisional application No. 61/194,672, filed on Sep. 29, 2008.

(51) Int. Cl. H04N 9/64

(52) U.S. Cl. 348/246; 348/E09.042

(57) ABSTRACT

A device can include a detection module and a correction module. The detection module can classify a pixel in a sensor as a defective pixel, and can store location information for the defective pixel. The correction module can identify the defective pixel based on the location information, and can correct a digital pixel signal corresponding to the defective pixel.

### RELATED APPLICATION

This application claims priority to U.S. Provisional Application No. 61/194,672, filed on Sep. 29, 2008, which is hereby incorporated by reference in its entirety.

### BACKGROUND

Light sensors, e.g., charge-coupled device (CCD) or complementary metal oxide semiconductor (CMOS) sensors, are usually used in the video or picture capturing device to capture the image. These sensors are made up of pixels which are designed and manufactured to form arrays. As more and more pixels are densely packed together, some of them may be defective in the horizontal or the vertical directions or both. The defective pixels may have an impact on the performance of the sensors.

FIG. 1 illustrates a typical pixel array 100 in a sensor. The pixels of the pixel array 100 can be arranged in a horizontal direction 102 and a vertical direction 104 such that each pixel (e.g., pixel 106) in the pixel array 100 has a horizontal coordinate and a vertical coordinate. The pixel 106 also has its own circuit to pass electric current upon detection of light by its own current sensor. The level of the electric current can be proportional to the amount of light detected.

FIG. 2 illustrates a prior art pixel data capturing and display system 200. The pixel data capturing and display system 200 includes a sensor 202, a controller 204, a video processor 206, and a video display/data storage device 208. The sensor 202 works as a front-end device for capturing image data and includes a sensor array 212, such as the sensor array 100 shown in FIG. 1, and an analog-to-digital converter (ADC) 214 for converting electric currents of the pixels to digital signals and sending digital pixel signal 224 to the video processor 206. The video processor 206 is used for processing the digital pixel signal 224 and sending processed digital pixel signal 226 to the video display/data storage device 208 for storing and/or displaying the processed digital pixel signal 226.

Any defective pixels in the sensor 202 resulting from the circuit design and/or sensor manufacturing processes may reduce the overall video or picture display quality.

### SUMMARY

A device can include a detection module and a correction module. The detection module can classify a pixel in a sensor as a defective pixel, and can store location information for the defective pixel. The correction module can identify the defective pixel based on the location information, and can correct a digital pixel signal corresponding to the defective pixel.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 is a diagram showing a pixel array within a sensor.

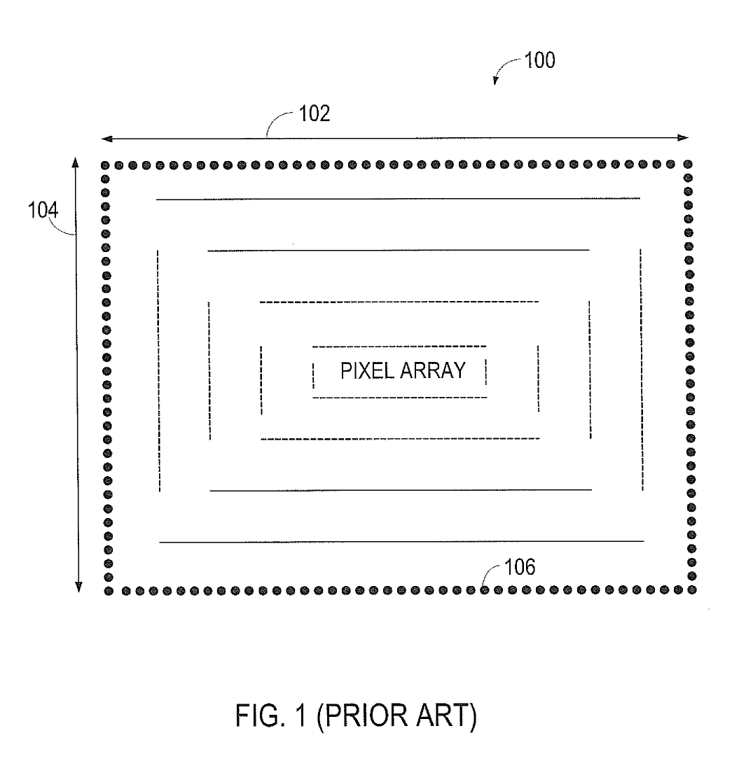

FIG. 2 is a block diagram showing a prior art pixel data capturing and display system.

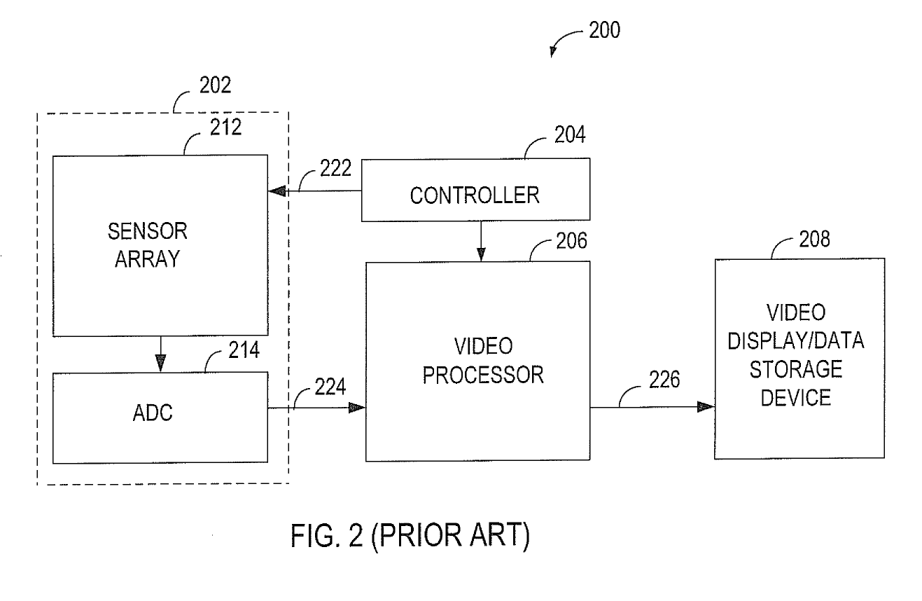

FIG. 3 is a block diagram showing a pixel data capturing and display system, in accordance with one embodiment of the present invention.

FIG. 4A is a block diagram showing a defective pixel detection and correction module, in accordance with one embodiment of the present invention.

FIG. 4B is a block diagram showing a defective pixel detection and correction module, in accordance with another embodiment of the present invention.

FIG. 5 is a pixel matrix of a matrix algorithm, in accordance with one embodiment of the present invention.

FIG. 6 is a block diagram showing a defective pixel detection module, in accordance with one embodiment of the present invention.

FIG. 7 is a block diagram showing a defective pixel correction module, in accordance with one embodiment of the present invention.

FIG. 8 is a flowchart showing a method for detecting and correcting a defective pixel in a sensor, in accordance with one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Embodiments described herein may be discussed in the general context of computer-executable instructions residing on some form of computer-usable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments. Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “exposing,” “storing,” “comparing,” “correcting,” “generating,” “determining,” “identifying,” “classifying,” “obtaining,” “utilizing” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

By way of example, and not limitation, computer-usable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information.

Communication media can embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of any of the above should also be included within the scope of computer-readable media.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

According to one embodiment of the present invention, a device can detect and correct defective pixels in a sensor. Digital pixel signals corresponding to pixels in the sensor are compared to a predetermined acceptance range. If a digital pixel signal corresponding to a pixel does not fall within the predetermined acceptance range, the pixel is classified as a defective pixel. Moreover, not only can the device detect defective pixels, but it also can correct the defective pixels automatically. For example, the non-defective pixels adjacent to the defective pixel can be utilized to correct the value of the digital pixel signal for the defective pixel. As such, corrected pixel signal can be provided by the device and the image quality can be improved.

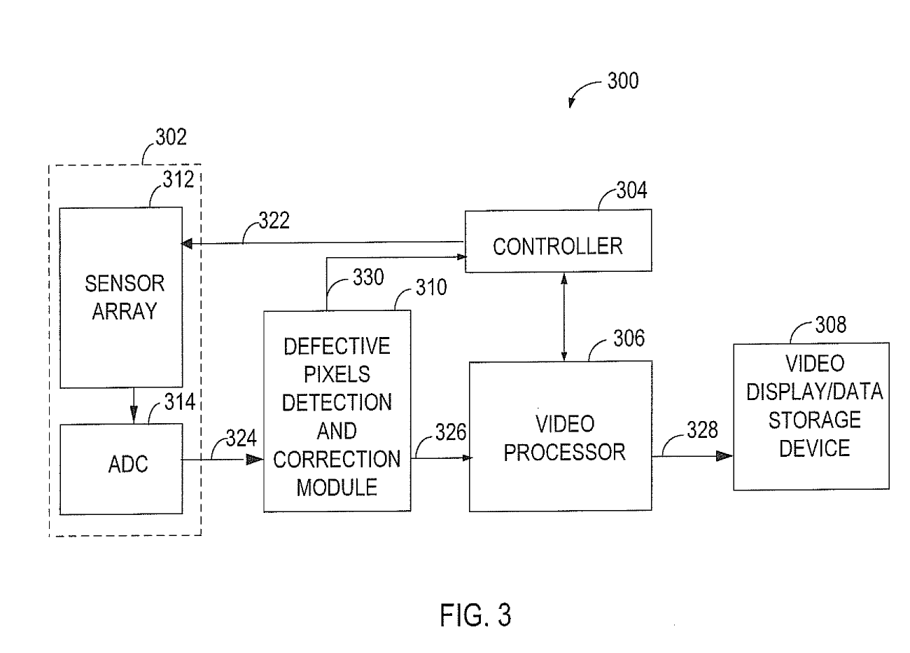

FIG. 3 shows a pixel data capturing and display system 300, in accordance with one embodiment of the present invention. The system 300 includes a sensor 302, a controller 304, a video processor 306, a video display/data storage device 308, and a defective pixel detection and correction module 310. The sensor 302 works as a front-end device for capturing image data and includes a sensor array 312 and an analog-to-digital converter (ADC) 314 for converting the electric currents of the pixels to digital signals, and for providing digital pixel signal 324 to the video processor 306 via the defective pixel detection and correction module 310.

In one embodiment, the defective pixel detection and correction module 310 receives the digital pixel signal 324, detects the potential defective pixels, and corrects the potential defective pixels so as to output corrected digital pixel signal 326, which will be described in detail hereinafter. In one embodiment, defective pixel detection and correction is performed prior to video processing. In such an embodiment, the video processor 306 can be customized without affecting the functionality of the defective pixel detection and correction module 310.

In one embodiment, the video processor 306 can process the corrected digital pixel signal 326, such as adjusting the contrast, the color saturation, the hue, the edge smooth, etc. Furthermore, the video processor 306 can compress the corrected digital pixel signal 326 in various formats such as Motion JPEG, MPEG1, MPEG2, MPEG4, etc. Thus, processed digital pixel signal 328 can be provided to the video display/data storage device 308. The video display/data storage device 308 can include a video display device, such as a liquid crystal display (LCD) TV/monitor, a plasma TV/monitor, for displaying the processed digital pixel signal 328, and/or a storage device, such as a flash memory, a hard disk, for storing the processed digital pixel signal 328.

The controller 304 is coupled to the sensor 302 and the video processor 306 to receive a control signal 330 from the defective pixel detection and correction module 310, and to control the sensor 302 and the video processor 306. A sensor control signal 322, such as a brightness control signal, a frame rate control signal, and/or a resolution control signal, is sent from the controller 304 to the sensor 302 for obtaining a desired output image quality. The controller 304 can also determine the time period to expose the pixels of the sensor 302 to light. In one embodiment, the defective pixel detection and correction module 310 can generate the control signal 330 and send it to the controller 304 to limit the exposure time of the sensor 302 to a predetermined period.

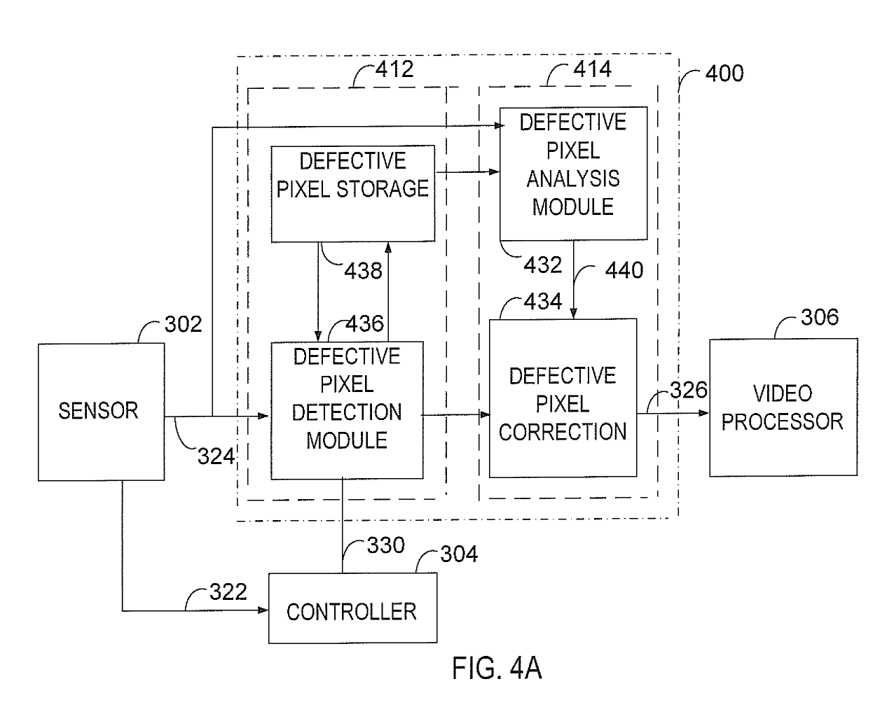

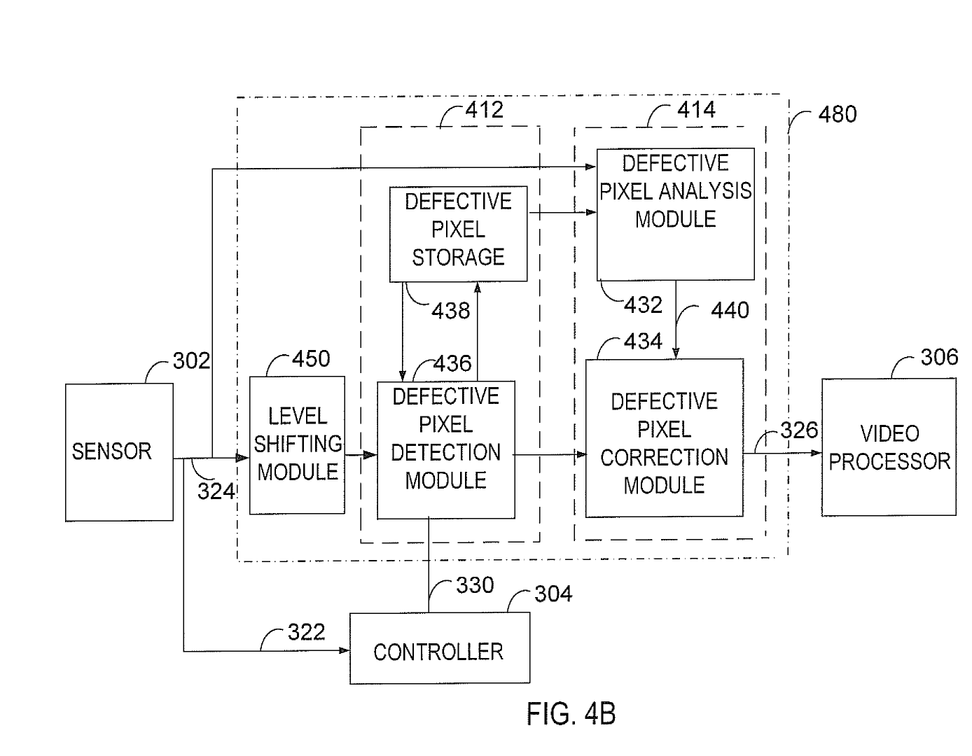

FIG. 4A shows a defective pixel detection and correction module 400, in accordance with one embodiment of the present invention. The defective pixel detection and correction module 400 is an example of the defective pixel detection and correction module 310 in FIG. 3. The defective pixel detection and correction module 400 includes a detection module 412 and a correction module 414, in one embodiment.

In one embodiment, the detection module 412 functions during a specific period, e.g., during the startup period of the sensor 302, to classify defective pixel(s) in the sensor 302 and to store corresponding location information (e.g., horizontal coordinates and vertical coordinates) for the defective pixels. In one embodiment, the detection module 412 includes a defective pixel detection module 436 and a defective pixel storage 438. When the sensor 302 and the controller 304 are powered up, the detection module 412 can generate the control signal 330 and send the control signal 330 to the controller 304 to limit the exposure time of the sensor 302 for a predetermined period. Digital pixel signal 324 captured by the sensor 302 is transmitted to the detection module 412. In one embodiment, the defective pixel detection module 436 can compare the digital pixel signal 324 for each of the pixels in the sensor 302 to a predetermined acceptance range, and can classify a pixel as a defective pixel when the corresponding digital pixel signal 324 of the pixel is outside of the predetermined acceptance range. As mentioned above, each pixel has a horizontal coordinate and a vertical coordinate to indicate the location information of the corresponding pixel in the sensor array. The corresponding horizontal and vertical coordinates of each defective pixel can be stored in the defective pixel storage 438.

In one embodiment, the predetermined acceptance range can include a first predetermined level/bright spot threshold and a second predetermined level/dark spot threshold.

In one embodiment, the sensor 302 is exposed to light for a predetermined time period. A pixel is marked as a bright spot and is classified as a defective pixel if the digital pixel signal 324 of the corresponding pixel is greater than the bright spot threshold, in one embodiment.

In another embodiment, the sensor 302 is exposed to light for a predetermined time period. A pixel is marked as a dark spot and is classified as a defective pixel if the digital pixel signal 324 of the corresponding pixel is less than the dark spot threshold, in one embodiment.

In another embodiment, the defective pixel detection and correction module 400 can further set a limit on the number of defective pixels and adjust the predetermined acceptance range in response to a change to the limit. For example, if the number of the bright spots or the dark spots exceeds the limit, the correction module 412 can adjust the predetermined range until the number of the bright spots or the dark spots is within the limit. The limit on the number of defective pixels can be set according to different requirements and applications.

The defective pixel storage 438 can receive location information from location counters (not shown in FIG. 4A but will be described below), and store the corresponding location information for the defective pixels. In one embodiment, a defective pixel array table in the defective pixel storage 438 can store the coordinate information for the defective pixels.

Advantageously, the location information for the defective pixel(s) stored in the defective pixel storage 438 can be automatically updated. For example, if the predetermined acceptance range is adjusted, the defective pixel(s) will change accordingly. In one embodiment, each time the predetermined acceptance range is adjusted, the location information of the defective pixel(s) can be updated, or in other words, the location information stored in the defective pixel storage 438 can be updated in response to a change to the predetermined acceptance range. In another embodiment, each time the sensor 302 and/or the defective pixel detection and correction module 400 is reset or restarted, the defective pixel detection process is performed and the latest defective pixel location information can be stored in the defective pixel storage 438, in other words, the location information stored in the defective pixel storage 438 can be updated in response to resetting the sensor 302 and/or the defective pixel detection and correction module 400. In another embodiment, the defective pixel location information provided by the defective pixel detection module 436 during every startup of the sensor 302 and/or the and the defective pixel detection and correction module 400 can be all stored in the defective pixel storage 438.

In one embodiment, sensors can have some advanced features such as the capability to output the digital pixel signal 324 according to desired resolutions or desired frame rates. According to one embodiment of the present invention, the detection module 412 is adapted for such advanced features. For example, the coordinates of the digital pixel signal 324 from the sensor 302 is represented as an “X” (horizontal coordinate) and a “Y” (vertical coordinate). Thus, the location information for the defective pixels can be stored as “X-Y” coordinates in the defective pixel storage 438. If a resolution is changed, e.g., according to a request from the user, a sensor control signal 322 can be sent from the controller 304. In one embodiment, the detection module 412 monitors the number of the pixels in the horizontal direction and the vertical direction in each frame to detect changes in resolution. If a resolution change is detected, the detection module 412 can re-obtain the corresponding horizontal and vertical coordinates of the defective pixels, which will be stored in the defective pixel storage 438 to indicate the location information for a defective pixel. As such, the information of the defective pixels can be updated for each resolution change.

Not only can the defective pixel detection and correction module 400 detect defective pixels, it also can correct the defective pixels automatically. In one embodiment, the correction module 414 can identify the defective pixel(s) based on the location information, and correct the digital pixel signal 324 corresponding to the defective pixel(s), then provides the corrected digital pixel signal 326 to the video processor 306. In other words, the defective pixels can be corrected without a correction instruction from the user. The correction module 414 includes a defective pixel analysis module 432 and a defective pixel correction module 434, in one embodiment.

The defective pixel analysis module 432 receives the digital pixel signal 324 with associated horizontal and vertical coordinate information, and compares the coordinate information for each pixel in the sensor 302 with the coordinate information for the defective pixels stored in the defective pixel storage 438, in one embodiment. If the location information for a pixel matches the location information for a defective pixel, the defective pixel analysis module 432 generates a correction parameter 440 based on an algorithm. In one embodiment, the correction parameter is calculated using the non-defective pixels adjacent to the defective pixel. In one embodiment, the correction parameter 440 can be generated by calculating the average value of the pixel data for non-defective pixels adjacent to (e.g., to the immediate left and right of) the defective pixel.

In one embodiment according to the present invention, the correction parameter 440 can be calculated by a matrix algorithm or a spatial filter algorithm to reconstruct the pixel data of the defective pixel using the adjacent vertical and horizontal non-defective pixels. In another embodiment, the correction parameter 440 can be obtained from the previous correction parameter in a progressive or interlace scan video. The correction parameter 440 can be calculated by different methods according to different applications.

In one embodiment, the defective pixel analysis module 432 employs an M*N pixel matrix in the matrix algorithm to generate the correction parameter 440. The correction parameter 440 can be obtained according to one or more of the following rules:

1. The correction parameter 440 can include a plurality of weighting factors. Each weighting factor corresponds to a pixel adjacent to the defective pixel. The summation of the defective weighting parameters in is a constant value, e.g., one.

2. The weighting factors for the pixels closer to the defective pixel can have a higher value.

3. To avoid floating point calculations, each weighting factor can be scaled to a number divided by two without residue.

4. The pixels to the left and right of the defective pixel (on the same horizontal line with the defective pixel) can have the highest weighting factors.

5. The pixels above and below the defective pixel (on the same vertical line of the defective pixel) can have the second highest weighting factors.

6. The pixels at a diagonal location above or below the defective pixels can have the lowest weighting factors.

FIG. 4B shows a defective pixel detection and correction module 480, in accordance with another embodiment of the present invention. The defective pixel detection and correction module 480 in FIG. 4B includes a level shifting module 450 for scaling the digital pixel signal 324 (e.g., expanding the scale of the digital pixel signal 324). In this embodiment, the level shifting module 450 scales the digital pixel signal 324 by adding an offset to or subtracting an offset from the digital pixel signal 324, before the digital pixel signal 324 is sent to the detection module 412.

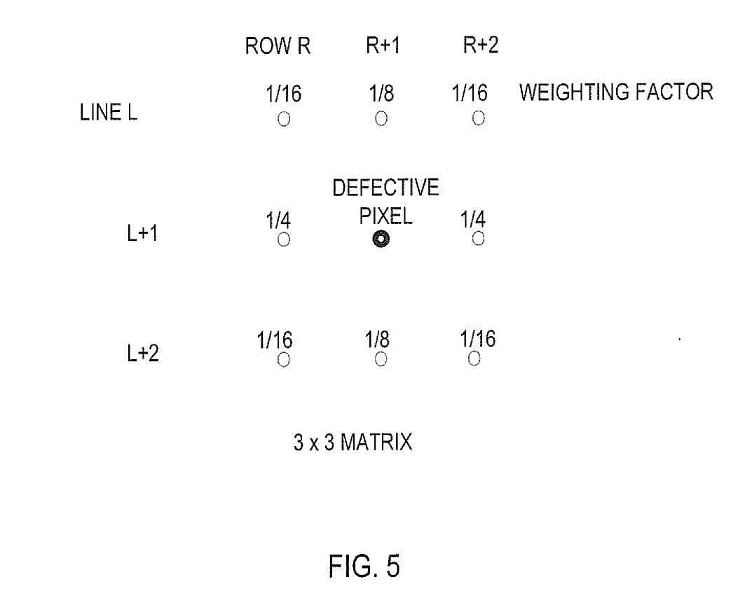

FIG. 5 illustrates an example of a three-by-three (3×3) pixel matrix showing the associated weighting factors of the adjacent/neighboring pixels according to one embodiment of the present invention. The weighting factors of the adjacent pixels in the 3×3 matrix can be used to generate the correction parameter 440 of the defective pixel.

As shown in FIG. 5, the horizontal coordinates (Line) of the pixels are L, L+1 and L+2, and the vertical coordinates (Row) of the pixels are R, R+1 and R+2. Thus, the location information for the defective pixel can be represented as (L+1, R+1). The weighting factors of neighboring pixels adjacent to the defective pixel are shown above the corresponding pixels. For example, the weighting factor of the pixel (L, R) is 1/16.

The defective pixel correction module 434 can receive the correction parameter 440 to correct the defective pixels by using the corresponding correction parameter 440, for example, according to the matrix algorithm or the spatial filter algorithm, and output the corrected digital pixel signal 326 to the video processor 306. In one embodiment, the corrected pixel value is a summation of each weighting factor multiplied by the corresponding pixel value V. For example, the corrected pixel value for the defective pixel (L+1, R+1) as shown in FIG. 5 can be obtained according to the following:

$$\frac{1}{16} \times {V}_{( L , R )} + \frac{1}{8} \times {V}_{( L , R + 1 )} + \frac{1}{16} \times {V}_{( L , R + 2 )} + \frac{1}{4} \times {V}_{( L + 1 , R )} + \frac{1}{4} \times {V}_{( L + 1 , R + 2 )} + \frac{1}{16} {V}_{( L + 2 , R )} + \frac{1}{8} \times {V}_{( L + 2 , R + 1 )} + \frac{1}{16} \times {V}_{( L + 2 , R + 2 )}$$

wherein the V(_{L, R}) is a pixel value of the pixel located in (L, R), V(_{L, R+1}) is a pixel value of the pixel located in (L, R+1), and so on.

In one embodiment, the defective pixel detection and correction module 400 can be used in a webcam external to or embedded in notebook/desktop computers. In another embodiment, the defective pixel detection and correction module 400 can be used in other applications, such as camera modules in cellular phones, PDA devices with camera modules, security surveillance systems, digital camera, etc.

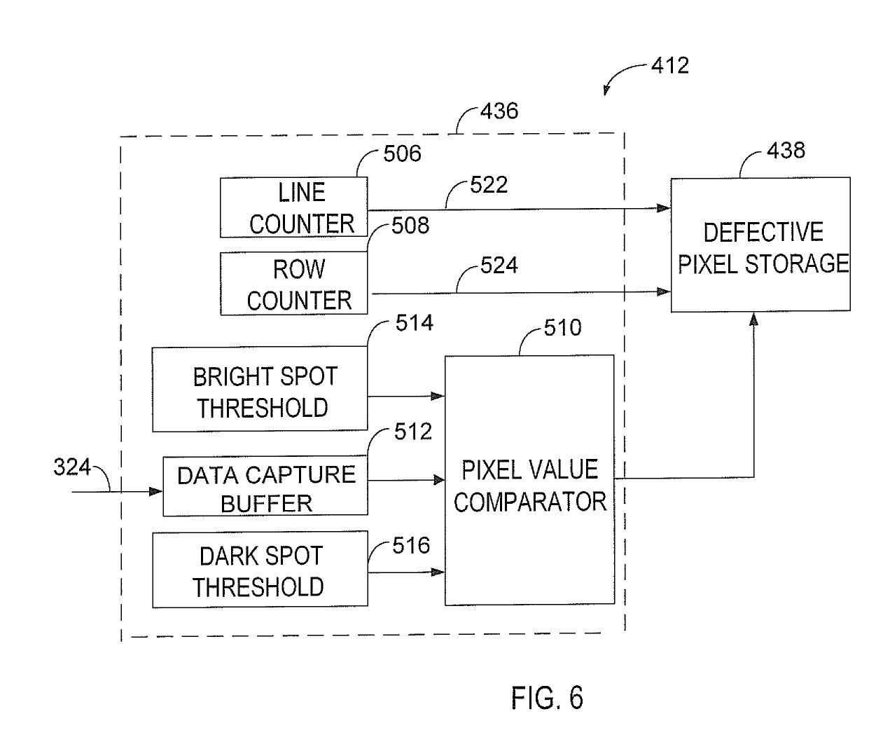

FIG. 6 shows a detection module 412, in accordance to one embodiment of the present invention. In one embodiment, the detection module 412 includes the location counters, such as a line counter 506 and a row counter 508, a data capture buffer 512 and a pixel value comparator 510.

The data capture buffer 512 can receive digital pixel signal 324 and transmit the digital pixel signal 324 to the pixel value comparator 510 to compare with a bright spot threshold 514 and a dark spot threshold 516. If the digital pixel signal 326 of a pixel is outside of the predetermined acceptance range for the bright spot threshold 514 and the dark spot threshold 516, the corresponding pixel will be classified as a defective pixel. The line counter 506 and the row counter 508 are used for providing a horizontal coordinate 524 and a vertical coordinate 522 of the defective pixel, and the horizontal coordinate 524 and the vertical coordinate 522 of the defective pixel are stored in the defective pixel storage 438.

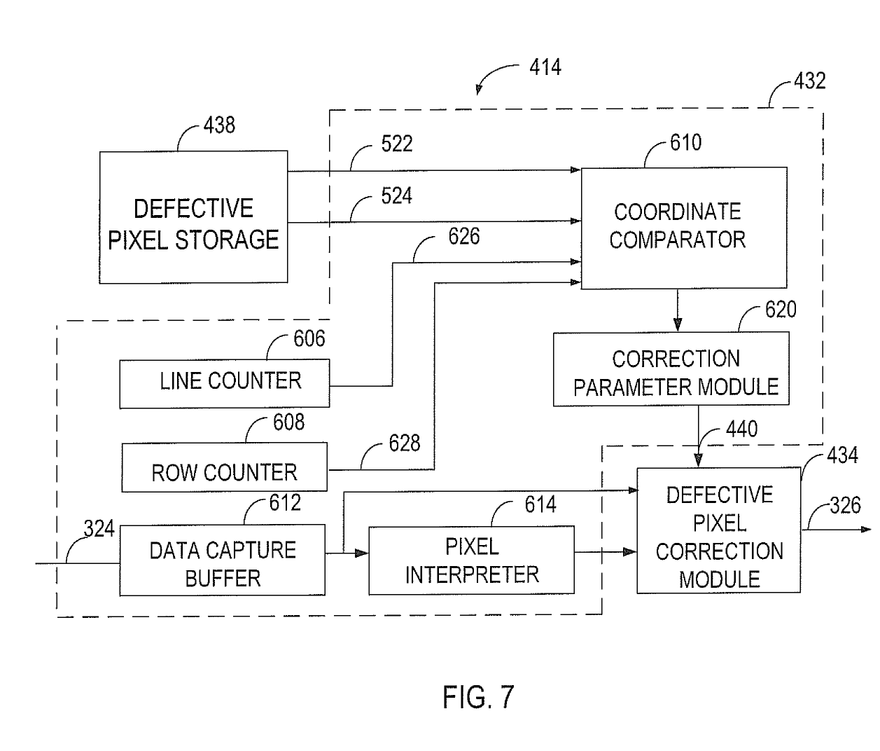

FIG. 7 shows a correction module 414, in accordance to one embodiment of the present invention. The correction module 414 includes a defective pixel analysis module 432 and a defective correction module 434, in one embodiment. The defective pixel analysis module 432 includes a line counter 606, a row counter 608, a data capture buffer 612, a coordinate comparator 610, and a correction parameter module 620, and cooperates with the defective pixel storage 438.

The defective pixel storage 438 provides the horizontal coordinate 524 and the vertical coordinate 522 of each defective pixel to the coordinate comparator 610, which compares the coordinates 524 and 522 with a horizontal coordinate 628 and a vertical coordinate 626 for each pixel provided by a line counter 606 and a row counter 608. If the coordinates of a pixel are matched with the coordinates of a defective pixel, the correction parameter module 620 can generate the correction parameter 440 according to the chosen correction algorithm. The defective correction module 618 employs the correction parameter 440 to output the corrected digital pixel signal 326 to correct the defective pixel.

In one embodiment according to the present invention, the defective pixel analysis module 602 further includes a pixel interpolator 614 to process the digital pixel signal 324 before sending it into the defective correction module 618. The pixel interpolator 614 changes the digital pixel signal 324 according to a specific interpolator algorithm for compatibility with the output corrected digital pixel signal 326. For example, when the digital pixel signal 324 includes 120-pixel information, but the corrected digital pixel signal requires 200-pixel information, the defective correction module 618 can scale the pixel number from 120 to 200. Similarly, a scaling can also be performed by the pixel interpolator 614 to decrease the pixel numbers. The quality of the output image can be adjusted by employing the pixel interpolator 614.

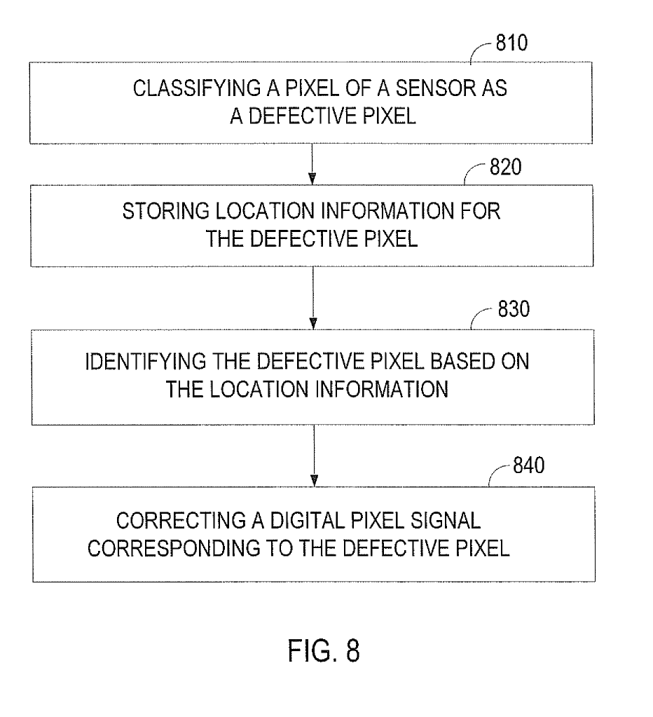

FIG. 8 shows a method 800 for detecting and correcting defective pixels, in accordance with one embodiment of the present invention. FIG. 8 is described in combination with FIG. 4A. A defective pixel detection and correction module 400 includes a defective pixel detection module 436, a defective pixel storage 438, a defective pixel analysis module 432, and a defective pixel correction module 434, in one embodiment. The method 800 can be implemented as computer-executable instructions stored in a computer-readable medium.

At 810, a pixel or pixels in a sensor are classified as defective pixel(s). To be more specific, defective pixel detection and correction module 400 sends a control signal 330 to a controller 304 to expose the sensor 302 to light for a predetermined period. Digital pixel signal 324 is obtained based on the exposure. In one embodiment, the digital pixel signal 324 includes digital pixel signals corresponding to respective pixels of the sensor 302. The digital pixel signal 324 for each pixel is compared with a predetermined acceptance range. A pixel is classified as a defective pixel when the digital pixel signal corresponding to it is outside of the predetermined acceptance range.

At 820, corresponding location information for a defective pixel can be stored in the defective pixel storage 438.

At 830, the defective pixel is identified based on its location information stored in the defective pixel storage 438.

At 840, a digital pixel signal corresponding to a defective pixel is corrected. The correction parameter 440 can be generated by the defective pixel analysis module 432 to correct a defective pixel. Neighboring pixels adjacent to the defective pixel are utilized to generate the correction parameter 440, in one embodiment.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A device, comprising:
a detection module operable for classifying a pixel of a sensor as a defective pixel, and for storing location information for said defective pixel; and
a correction module coupled to said detection module and operable for identifying said defective pixel based on said location information, and for correcting a digital pixel signal corresponding to said defective pixel.

2. The device of claim 1, wherein said detection module compares a plurality of digital pixel signals for a plurality of pixels with a predetermined acceptance range, wherein a pixel that produces a digital pixel signal outside of said predetermined acceptance range prior to said correcting is classified as a defective pixel.

3. The device of claim 2, wherein said detection module is operable for updating said location information in response to a change to said predetermined acceptance range.

4. The device of claim 2, wherein said predetermined acceptance range comprises a first predetermined level and a second predetermined level.

5. The device of claim 1, wherein said detection module receives said location information from a location counter.

6. The device of claim 5, wherein said location counter provides coordinates for said defective pixel.

7. The device of claim 1, wherein said detection module is operable for scaling said digital pixel signals.

8. The device of claim 1, wherein said correction module is operable for providing a correction parameter for said defective pixel based on an algorithm, wherein said correction module corrects said digital pixel data corresponding to said defective pixel based on said correction parameter.

9. The device of claim 8, wherein said algorithm is a matrix algorithm using a pixel matrix.

10. A system, comprising:
a sensor having a plurality of pixels;
a defective pixel detection and correction module coupled to said sensor and operable for comparing a plurality of digital pixel signals corresponding to said pixels with a predetermined acceptance range, said module also operable for classifying a pixel as a defective pixel, wherein a digital pixel signal for said defective pixel is outside of said predetermined acceptance range, said module also operable for correcting said digital pixel signal after said classifying; and
a controller coupled to said sensor and said defective pixel detection and correction module and operable for receiving a control signal from said defective pixel detection and correction module, and for controlling said sensor.

11. The system of claim 10, wherein said control signal received by said controller is operable for limiting exposure time of said sensor for a predetermined period.

12. The system of claim 10, wherein said defective pixel detection and correction module is operable for setting a limit on the number of defective pixels, and for adjusting said predetermined acceptance range in response to a change to said limit.

13. The system of claim 10, wherein said defective pixel detection and correction module stores location information for said defective pixel.

14. The system of claim 13, wherein said defective pixel detection and correction module is operable for updating said location information in response to a change to said predetermined acceptance range.

15. The system of claim 13, wherein said defective pixel detection and correction module is operable for updating said location information in response to resetting said sensor.

16. The system of claim 10, further comprising a video processor for processing corrected digital pixel signals provided by said defective pixel detection and correction module.

17. A method, comprising:
classifying a pixel of a sensor as a defective pixel;
storing location information for said defective pixel;
identifying said defective pixel based on said location information; and
correcting a digital pixel signal corresponding to said defective pixel.

18. The method of claim 17, further comprising:
exposing said sensor to light for a predetermined period;
obtaining a plurality of digital pixel signals based on said exposure, wherein said digital pixel signals correspond to a plurality of pixels of said sensor;
comparing said plurality of digital pixel signals with a predetermined acceptance range; and
classifying said defective pixel, wherein a pixel that produces a digital pixel signal outside of said predetermined acceptance range prior to said correcting is classified as a defective pixel.

19. The method of claim 17, further comprising generating a correction parameter for correcting said defective pixel.

20. The method of claim 19, further comprising utilizing a plurality of neighboring pixels adjacent to said defective pixel to generate said correction parameter.
